(19) United States
(12) Patent Application Publication
(10) Pub. No.: US 2017/0357944 A1
(43) Pub. Date: Dec. 14, 2017

(54) METHODS AND SYSTEMS FOR GENERATING A PERSONNEL RECORDS DATABASE

(71) Applicant: MASTERCARD INTERNATIONAL INCORPORATED, Purchase, NY (US)

(72) Inventor: Arunmurthy Gurunathan, Pune (IN)

(21) Appl. No.: 15/616,598

(22) Filed: Jun. 7, 2017

(30) Foreign Application Priority Data
Jun. 14, 2016 (SG) 10201604842P

(51) Int. Cl. G06Q 10/10; G06Q 50/20

(52) U.S. Cl. CPC G06Q 10/1053; G06Q 50/2057

(57) ABSTRACT

Methods and systems for generating a personnel records database are disclosed. The personnel records database includes data entries associated with a plurality of human subjects. In one aspect, the method includes a computer server, for each of a plurality of human subjects, (a) receiving, over a communication network, information characterizing an educational qualification held by the human subject, wherein said information is indicative of an identity of an educational institution associated with the education qualification and an identity of the human subject; (b) transmitting an electronic request for verification of the educational qualification to a verification server; (c) receiving an outcome of the verification from the verification server; and if the verification is successful, (di) generating a data entry associating the educational qualification with the identity of the associated human subject; and (dii) storing the data entry in a database in communication with the computer server.

### TECHNICAL FIELD

The present disclosure relates to methods and systems for generating a personnel records database. In particular, computerized-methods and systems are provided for managing personnel records of a plurality of human subjects, for example, in relation to employment of the human subjects.

### BACKGROUND

During a typical recruitment process, potential candidates (i.e. human subjects) are usually required to disclose certain information about themselves to a prospective employer. The information typically includes their educational qualifications and previous employment history, if applicable. The prospective employer takes such information into account when making a hiring decision. As a part of the process, the potential candidates may be required to supply supporting documents such as degree certificates and previous employment letters to the employer (or prospective employer) to prove truthfulness of the information provided. The employer may further engage a third party company to conduct background checks on the employees (or prospective employee) and to provide reports on their background details.

However, the above process is a time-consuming process and needs to be repeated every time when an employee leaves for a new employer, or when an employer makes a new hire, which is tedious for both the employers and employees.

Therefore, it is desirable to provide improved methods and systems which simplify the process for obtaining personnel information about employees, which may be relevant to their current or prospective employment.

### SUMMARY

In general terms, the present disclosure proposes a centralized personnel records database management system which automatically obtains verification of educational qualifications for a plurality of human subjects, and generates and maintains data records associated with the plurality of human subjects. The data records may optionally comprise other information such as current or past employment information of the human subjects with respective employers (i.e. employing organizations). A personnel records database may be formed comprising data entries associated with the plurality of human subjects and the database may be made accessible by a plurality of interested parties (e.g. employers or prospective employers) for obtaining personnel information about a given human subject.

In particular, according to a first aspect, there is provided a method of generating a personnel records database comprising data entries associated with a plurality of human subjects. The method comprises a computer server performing operations of:
for each of a plurality of human subjects,
(a) receiving, over a communication network, information characterizing an educational qualification held by the human subject, wherein said information is indicative of an identity of an educational institution associated with the education qualification and an identity of the human subject;
(b) transmitting an electronic request for verification of the educational qualification to a verification server;
(c) receiving an outcome of the verification from the verification server; and
if the verification is successful,
   (di) generating a data entry associating the educational qualification with the identity of the associated human subject; and
   (dii) storing the data entry in a database in communication with the computer server.

The above method may allow a centralized records management system for a plurality of human subjects to be established. The computer server may be configured to automatically obtain verification of an educational qualification upon receiving relevant input information. In addition, a personnel records database comprising verified educational qualifications for each of the plurality of human subjects may be generated. The personnel records database may be made accessible by a plurality of unrelated parties, for example, by different employers which do not typically share information about their employees, prospective employees or ex-employees directly, to obtain true and verified information about a given human subject. This may eliminate a need for each of the employers (which may be successors in title of an employee, or all of which may be prospective employers of an employee) to engage third parties to independently verify the educational qualification of the given human subject afresh.

In one embodiment, the verification server may be in communication with servers of a plurality of educational institutions. The verification server is configured to obtain verification of the respective educational qualification from the server of the associated educational institution. The verified educational qualification may be a form of a digital certificate endorsed by the server of the associated educational institution. The educational qualification may be verified in any other form such as receiving a digital approval message from the server.

In one embodiment, the method may further comprises receiving information characterizing a second educational qualification held by the human subject and performing operations (a)-(dii) to update the database.

In one embodiment, the method may comprise, prior to operation (a), receiving registration information associated with the human subject to register the human subject with the computer server.

In one embodiment, the computer server may be in communication with servers of a plurality of employing organizations. For a given human subject having an employment relationship with one or more of the employing organizations, the computer server may receive employment information characterizing the human subject's employment with the employing organization. The employment information is received from the server of the corresponding employing organization. The database may be updated to further associate the employment information with the human subject. The database may be updated by modifying the existing data entry associated the human subject to include the employment information. Alternatively, a new data entry comprising the identity of the human subject and the employment information may be generated to associate the employment information with the human subject and the data entry is stored in the database.

In one embodiment, the employment information may comprise at least one of (i) a commencement date of the employment, (ii) a cessation date of the employment, and (iii) a duration of the employment.

In one embodiment, the employment information may comprise one or more of (i) wage information in relation to the employment, (ii) an employee's provident fund contributed in relation to the employment, (iii) an employment allowance in relation to the employment, and (iv) other benefits-in-kind in relation to the employment.

In one embodiment, the employment information comprises one or more of (i) an identity of the employing organization, (ii) a location of the employing organization, (iii) a job designation of the employment, (iv) a scope of professional responsibilities during the course of the employment, and (v) a reason for cessation of the employment.

In one embodiment, the computer server is in communication with a provident-fund server of an employee's provident fund organization at which provident fund accounts of the human subjects are maintained. The employee's provident fund organization is typically a government authority which administers mandatory social security savings scheme funded by contributions from employers and employees. The provident-fund server administers the provident fund accounts of the human subject. This may provide a comprehensive system which integrates the administration of provident-fund contributions and personnel information of the plurality of human subjects. This further assures the accuracy and truthfulness of the employment data records, including the employee's provident-fund contribution, captured by the system.

In some embodiments, the computer server is the provident-fund server of an employee's provident fund organization, which administers the provident fund accounts of the human subjects.

In one embodiment, the computer server is configured to receive an electronic request for personnel records associated with a given human subject, the method comprising:
(g) the computer server retrieving, from the database, the data entry associated with the human subject in response to the electronic request; and
(h) transmitting the data entry to a computing device pursuant to the electronic request.

In one embodiment, the data entry is transmitted to a server of a prospective employing organization of the human subject.

In one embodiment, the method may include, prior to operations (g)-(h), obtaining an authorization from the human subject, and performing operations (g)-(h) upon successful authorization.

In one embodiment, prior to operation (e), the computer server receives registration information associated with the employing organizations to register the employing organizations with the computer server.

In one embodiment, the method further may comprise receiving medical records of the human subject, and updating the database to further associate the medical records with the human subject.

In one embodiment, the method may further comprise receiving conduct records of the human subject, and updating the database to further associate the conduct records with the human subject.

According to a second aspect, there is provided a computer server for generating a personnel records database comprising data entries associated with a plurality of human subjects. The computer server comprises a server processor, a data storage device storing server processor program instructions, the server processor program instructions being operative to cause the server processor:
for each of a plurality of human subjects,
(a) to receive information characterizing an educational qualification held by the human subject, wherein said information is indicative of an identity of an educational institution associated with the education qualification and an identity of the human subject;
(b) to transmit an electronic request for verification of the educational qualification to a verification server;
(c) to receive an outcome of the verification from the verification server; and
if the verification is successful,
   (di) to generate a data entry associating the educational qualification with the identity of the associated human subject; and
   (dii) to store the data entry in a database in communication with the server processor.

The data storage device may stores further server processor program instructions operative to cause the server processor to perform the method according to any one of methods described above.

According to another aspect, there is provided a method of obtaining employment information associated with a given human subject. The method comprises:
(a) transmitting an electronic request for personnel records associated with the human subject to an authorization server, and
(b) upon authorization by the authorization server, interrogating a personnel records database generated according to any one of the method described above to retrieve the data entry associated with the human subject.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

According to a further aspect, there is provided a personnel records management system which comprises:
a computer server and a database in communication with the computer server;
the computer server having a server processor and a data storage device storing server processor program instructions, the server processor program instructions being operative to cause the server processor:
for each of a plurality of human subjects,
(a) to receive information characterizing an educational qualification held by the human subject, wherein said information is indicative of an identity of an educational institution associated with the education qualification and an identity of the human subject;
(b) to transmit an electronic request for verification of the educational qualification to a verification server;
(c) to receive an outcome of the verification from the verification server; and
if the verification is successful,
   (di) to generate a data entry associating the educational qualification with the identity of the associated human subject; and
   (dii) to store the data entry in the database.

According to yet a further aspect, there is provided a computerized network which comprises:
a computer server;
a verification server in communication with the computer server, said verification server being configured to obtain verification of an educational qualification associated with an educational institution; and
a database in communication with the computer server;
said computer server comprising a server processor, a data storage device storing server processor program instructions, the server processor program instructions being operative to cause the server processor, for each of a plurality of human subjects:
(a) to receive information characterizing an educational qualification held by the human subject, wherein said information is indicative of an identity of an educational institution associated with the education qualification and an identity of the human subject;
(b) to transmit an electronic request for verification of the educational qualification to a verification server;
(c) to receive an outcome of the verification from the verification server; and
if the verification is successful,
   (di) to generate a data entry associating the educational qualification with the identity of the associated human subject; and
   (dii) to store the data entry in the database in communication with the server processor;
wherein the computerized network further comprises servers of a plurality of employing organizations in communication with the server processor, the server processor program instructions being operative to cause the server processor:
for the human subject having an employment relationship with one or more said employing organizations,
   (e) to receive, from the server of the employing organization, employment information characterizing the human subject's employment with the employing organization, and
   (f) to update the database to further associate the employment information with the human subject.

The term “employing organization” refers to any entity which hires one or more human subjects to perform work for the entity for a wage. Accordingly, the term “employment relationship” defines a relationship between an employing organization and an employee who is engaged to perform work under a contract of hire. Note that the employment relationship may refer to current or past employment relationship between the employing organization and the employee.

The term “educational institution” may be any entity that provides instructional services to individuals or education-related services to individuals and/or institutions. In particular, it may include, but is not limited to, preschools, elementary schools, high schools, universities, or institutions which provide technical or vocational education or trainings programmers. In this document, educational institutions may also include educational authorities, special examining bodies and/or professional bodies.

In this document, the term “educational qualifications” refers to degrees, diplomas, certificates, professional titles and the like that an individual has acquired by study and conferred by educational institutions. The study may be full-time study, part-time study or private study. Typically, the acquisition of an educational qualification therefore implies the successful completion of a course of study, a training program or a professional examination.

The term “automatically” is used in the document to mean that, although human interaction may initiate the process, human interaction is not required while the process is carried out.

### BRIEF DESCRIPTION OF THE DRAWINGS

Embodiments of the present disclosures will now be described for the sake of non-limiting examples only, with reference to the following drawings in which:

FIG. 1 shows schematically a computerized payment network which is suitable to perform a method which is an embodiment;

FIG. 2 is a flow diagram of a method according to an embodiment;

FIG. 3 is a flow diagram of a method according to another embodiment; and

FIG. 4 is a block diagram showing a technical architecture of a computer server suitable for implementing the present method.

### DETAILED DESCRIPTION

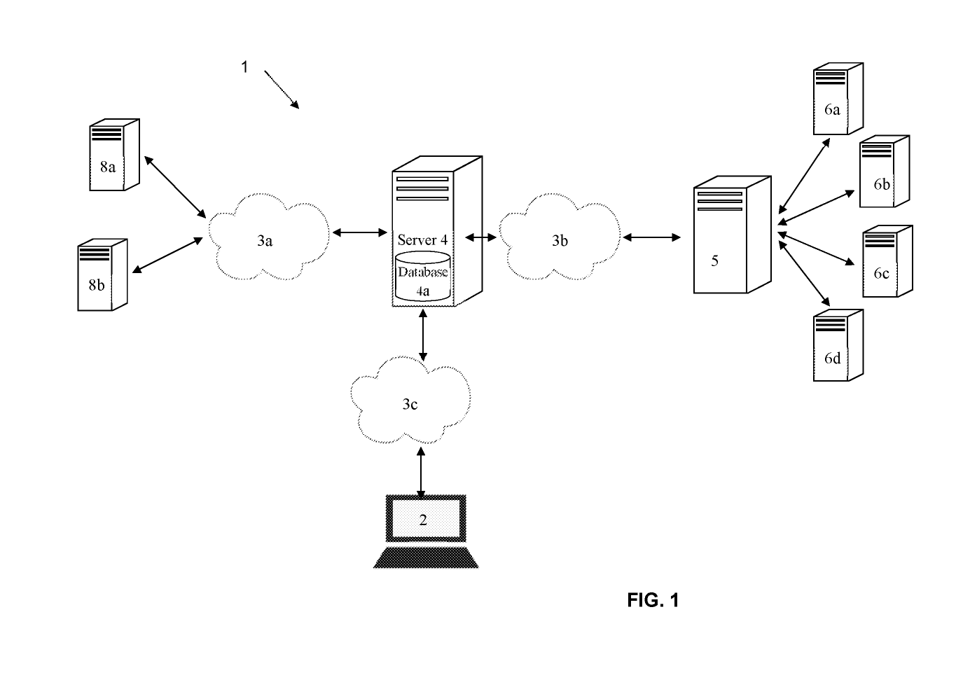

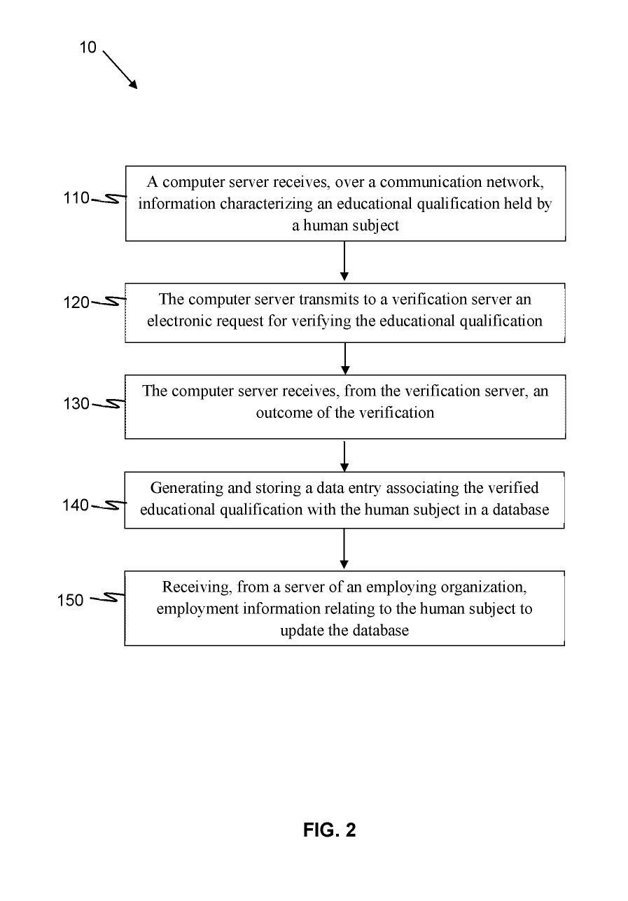

Referring to FIG. 1, a computerized network 1 is shown which is suitable for performing a method of an embodiment as illustrated by FIG. 2.

The computerized network 1 comprises a personnel records management (PRM) system. The PRM system has a personnel records management (PRM) server 4 which stores a personnel records database 4a. In another example, the personnel records database 4a is located remote from the PRM server 4. The personnel records database 4a is configured to be accessible by the PRM server 4 over a communication network.

The PRM server 4 is configured to handle requests and/or communication from employing organizations, educational institutions, and individual users, that is, human subjects such as employees or prospective employees). The PRM server 4 is in communication with servers 8a, 8b of the employing organizations, a verification server 5, and a user's terminal 3c over communication networks 3a, 3b, 3c. The communication network 3a, 3b, 3c may be any types of communication network, for example, virtual private network (VPN), the Internet, a local area and/or wide area network (LAN and/or WAN), a wi-fi network, or a 3G or 4G telecommunication network.

The embodiment illustrates a PRM server 4 which is communication with servers 6a, 6b, 6c, 6d of a plurality of educational institutions via a centralized verification server 5. It will be understood that the PRM server 4 may be in direct communication each of the servers 6a, 6b, 6c, 6d via the communication network 3a, and in that case, the servers 6a, 6b, 6c, 6d may be regarded as verification servers.

FIG. 2 illustrates a flow of an exemplary method 10. It should be noted that the method 10 below describes a process of generating and managing data records for a user. It will be understood that a personnel records database comprising data entries for a plurality of users may be formed by performing the method 10 for each of them. The embodiment also illustrates that the user inputting information via a laptop computer 2, but it will be appreciated by a skilled person in the art that other communication devices may be used such as a mobile phone, a tablet computer, a desktop computer or the like. It should also be noted that enumeration of operations is for purposes of clarity and that the operations need not be performed in the order implied by the enumeration.

At operation 110, the user (i.e. a human subject) submits information of his/her educational qualification to the PRM server 4 using a laptop 2. For example, the user may upload a digital copy of a degree certificate or a transcript issued by a university to the PRM server 4. The PRM server 4 receives the information over a communication network 3c from the laptop 2. In another example, the user may be prompted to fill in relevant information fields on a digital form provided by the PRM server 4 via a web-browser or a mobile application user interface.

The PRM server 4 may receive information such as an identity of the educational institution, a level of the education institution (e.g. primary, secondary, tertiary, higher or further education), an academic degree or diploma (and optionally a class of the degree or diploma) conferred by the educational institution. The information may further include a course of study (and optionally a specialization) undertaken by the user, a duration of the course, a year of graduation, a matriculation number or a student ID associated with the user, and/or any other details concerning the user's education history.

Optionally, the PRM server 4 may request the user to pre-register with the PRM system by entering registration information of the user. The registration information may comprise a full name of the user, an Identification Card number of the user, a social security number of the user, an age of the user, a residential address of the user, an email address of the user and/or other information which allows the user to be identified uniquely within a context.

At operation 120, the PRM server 4 transmits an electronic request to the verification server 5 to request verification of the educational qualification submitted by the user. The verification server 5 may communicate with the corresponding educational institution, such as university, which certifies whether or not the education qualification was awarded to the identified human subject by the university. The educational institution may further certifies or provide educational information relating to the human subject. The educational information may be a course of study (and optionally a specialization) undertaken by the human subject, a duration of the course, a year of graduation, a matriculation number or a student ID, and/or any other details concerning the education history.

At operation 130, the verification server 5 transmits an outcome of the verification to the PRM server 4. The outcome of the verification may be received in a form of a digital certificate endorsed by the server of the university. In another example, the verification outcome may be received in any other form, such as a digital approval message from the server of the university. If the verification is successful, the PRM server 4 generates and stores a data entry for the human subject at operation 140. The data entry comprises an identity of the human subject and the verified educational qualification. If more than one educational qualification is submitted, the data entry further associates the further educational qualification with the human subject. The personnel records database 4a may be updated by modifying the existing data entry associated the human subject to include the second educational qualification. Alternatively, a new data entry comprising the identity of the human subject and the second educational qualification may be generated to associate the two.

Similarly, for a plurality of human subjects, a data entry may be created for each of them and the associated data entries are stored in the personnel records database 4a.

In this example, the method 10 further comprises an optional operation 150 in which the PRM server 4 receives employment information relating to the human subject. In this example, the given human subject has an employment relationship with each of the employing organizations. The employment relationship may be in a present employment relationship or a past employment relationship. In particular, the PRM server 4 receives from the server 8a of the current employing organization employment information characterizing the human subject's current employment. The PRM server 4 may also receive from the server 8b of a former employing organization employment information characterizing the human subject's past employment with the ex-employer.

For example, the employment information may include a commencement date of the employment, a cessation date of the employment, and/or a duration of the employment.

For another example, the employment information may also include wage information concerning the employment, an employee's provident fund contributed in relation to the employment, an employment allowance concerning the employment, and/or other benefits-in-kind concerning the employment.

In some embodiments, the employment information may alternatively or additionally include a full name of the employing organization, a location of the employing organization, a job designation of the employment, a scope of professional responsibilities during the course of the employment, and/or a reason for cessation of the employment.

The personnel records database 4a is updated by the PRM server 4 to further associate the employment information with the human subject. Similarly, the personnel records database 4a may be updated by modifying the existing data entry associated the human subject to include the employment information. Alternatively, a new data entry comprising the identity of the human subject and the employment information may be generated to associate the employment information with the human subject and the data entry is stored in the personnel records database 4a.

In use, the PRM server 4 may receive an electronic request for personnel records associated with a human subject. In response to the electronic request, the PRM server 4 interrogates the personnel records database 4a to retrieve the data entry associated with the given human subject. The information relating to the human subject is then transmitted to a party based on the electronic request.

For example, the electronic request may be initiated by a prospective employing organization which seeks to validate a candidate employee's background information. The PRM server 4 may transmit the requested information associated with the human subject to the prospective employing organization. In this example, an authorization step may be optionally performed before transmitting the information. For example, the PRM server 4 may notify the human subject and obtain confirmation from the human subject authorizing release of the information to the prospective employing organization, if the human subject agrees to the release.

In another example, the electronic request may be initiated by the human subject himself or herself who wishes to supply verified information about himself or herself to a prospective employing organization. In that case, the human subject may request the PRM server 4 to transmit information about the human subject to the relevant organization.

In some embodiments, the method 10 may further include an operation of registering the plurality of employing organizations with the PRM system. The PRM server 4 may be configured to receive the employment information from only the registered employing organizations to update the database 4a. Alternatively or additionally, the PRM server 4 may be configured to process an electronic request for personnel records concerning a human subject from only registered employing organizations.

It should be noted that various operations of the method 10 may not be performed in the sequenced implied by the enumeration. For example, a data entry comprising the employment information of the human subject may be generated prior to the educational information. In particular, the PRM server 4 may obtain the employment information first before receiving the educational information relating to the human subject. In another example, the PRM system may receive and stores additional information, such as medical records and conduct records relating to the human subjects.

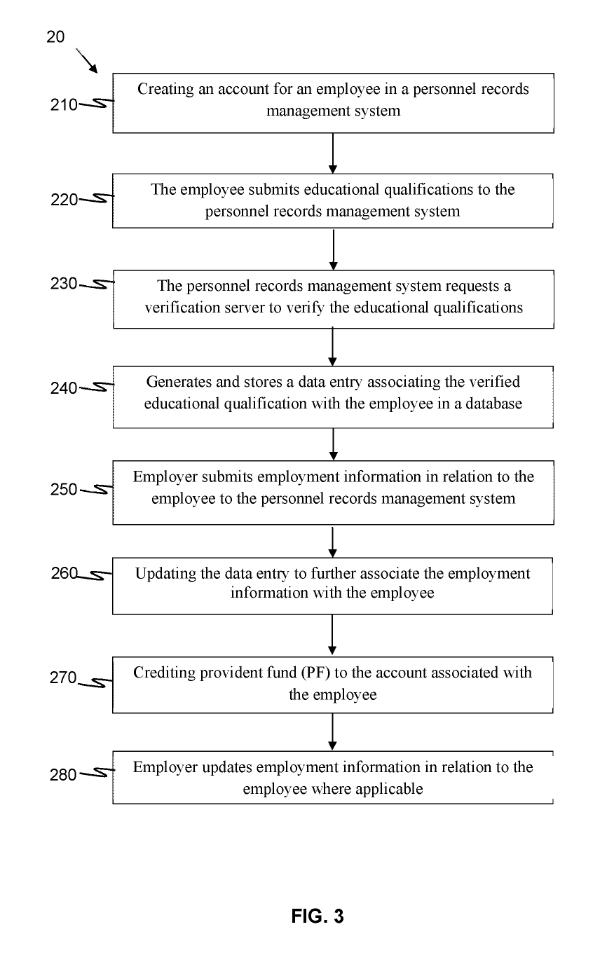

Referring to FIG. 3, there is illustrated a method 20 according to another embodiment. In this embodiment, the PRM server 4 is in communication with a provident fund server of an employee's provident fund organization at which provident fund accounts of the human subjects are maintained. The employee's provident fund organization is typically a government authority which administers a mandatory social security savings scheme funded by contributions from employers and/or employees. The provident fund server administers the provident fund accounts of the human subject. The PRM server 4 may be configured to, upon being granted permission, retrieve account information relating to the provident fund accounts from the provident fund server. In a variant embodiment, the PRM server itself is the provident-fund server.

At operation 210, an account for an employee is created by registering the employee with the personnel records management system. The account may be created by the employer or employee inputting required registration information with the personnel records management system.

The method 20 further includes steps of the employee submitting information relating to educational qualifications to the personnel records management system (i.e. operation 220), transmitting the information for verification of the educational qualifications (i.e. operation 230), and generating and storing a data entry associating the verified educational qualifications with the employee in the personnel records database 4a (i.e. operation 240). These operations may be performed similarly to operations 120-140 described in the earlier embodiment.

At operation 250, the current employing organization uploads employment information in relation to the employee to the PRM system. At operation 260, the data entry in the personnel records database 4a is updated to associate the employment information with the employee.

In some embodiments, the current employing organization may, at operation 270, start crediting the provident fund to the account associated with the employee via the PRM server 4.

At operation 280, the employing organization may update employment information in relation to the employee with the personnel records management system wherever applicable, for example, whenever there is any change to the employment information such as wage information, a job designation, a cessation of employment, etc. Additionally or alternatively, a new employing organization may update employment information in relation to the employment regarding a change of employment for the employee. For example, when the employee moves from a first employing organization to a second employing organization.

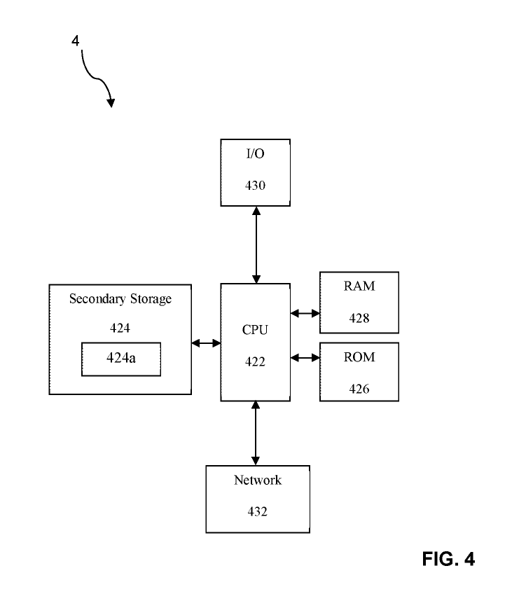

FIG. 4 is a block diagram showing a technical architecture of a server (e.g. the PRM server 4) suitable for implementing the present embodiments.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, embodiments, it will be understood by those skilled in the art that many variations of the embodiment can be made within the scope and spirit of the present invention. For example, the educational qualification may be a professional qualification and the method involves a step of seeking verification from the relevant professional body. For another example, additional security features may be implemented when handling the data records to ensure local regulations, such as privacy or personal data protection law, are complied with.

1. A method of generating a personnel records database comprising data entries associated with a plurality of human subjects, the method comprising a computer server:
for each of a plurality of human subjects,
(a) receiving, over a communication network, information characterizing an educational qualification held by the human subject, wherein said information is indicative of an identity of an educational institution associated with the education qualification and an identity of the human subject;
(b) transmitting an electronic request for verification of the educational qualification to a verification server;
(c) receiving an outcome of the verification from the verification server; and
if the verification is successful,
(di) generating a data entry associating the educational qualification with the identity of the associated human subject; and
(dii) storing the data entry in a database in communication with the computer server.

2. The method according to claim 1, wherein the verification server is in communication with servers of a plurality of educational institutions, wherein the verification server is configured to obtain verification of the respective educational qualification from the server of the associated educational institution.

3. The method according to claim 1 further comprising the computer server receiving information characterizing a second educational qualification held by the human subject and performing operations (a)-(dii) to update the database.

4. The method according to claim 1 further comprising, prior to operation (a), receiving registration information associated with the human subject to register the human subject with the computer server.

5. The method according to claim 1, wherein the computer server is in communication with servers of a plurality of employing organizations, the method further comprising:
for a given human subject having an employment relationship with one or more said employing organizations,
(e) receiving, from the server of the employing organization, employment information characterizing the human subject's employment with the employing organization, and
(f) updating the data entry to further associate the employment information with the human subject.

6. The method according to claim 5, wherein the employment information comprises at least one of (i) a commencement date of the employment, (ii) a cessation date of the employment, and (iii) a duration of the employment.

7. The method according to claim 5, wherein the employment information comprises at least one of (i) wage information concerning the employment, (ii) an employee's provident fund contributed in relation to the employment, (iii) an employment allowance concerning the employment, and (iv) other benefits-in-kind concerning the employment.

8. The method according to claim 5, wherein the employment information comprises at least one of (i) an identity of the employing organization, (ii) a location of the employing organization, (iii) a job designation of the employment, (iv) a scope of professional responsibilities during the course of the employment, and (v) a reason for cessation of the employment.

9. The method according to claim 5, wherein the computer server is in communication with a provident-fund server of an employee's provident fund organization, wherein the provident-fund server administers the provident fund accounts of the human subject.

10. The method according to claim 5, wherein the computer server is a provident-fund server of an employee's provident fund organization and the computer server administers the provident fund accounts of the human subject.

11. The method according to claim 5, wherein the computer server is configured to receive an electronic request for personnel records associated with a given human subject, the method comprising:
(g) the computer server retrieving, from the database, the data entry associated with the human subject in response to the electronic request; and
(h) transmitting the data entry to a computing device pursuant to the electronic request.

12. The method according to claim 11 further comprising transmitting the data entry to a server of a prospective employing organization of the human subject.

13. The method according to claim 11 further comprising, prior to operations (g)-(h), obtaining authorization from the human subject, and performing operations (g)-(h) upon successful authorization.

14. The method according to claim 5 further comprising, prior to operation (e), receiving registration information associated with the employing organizations to register the employing organizations with the computer server.

15. The method according to claim 1, wherein the method further comprises receiving medical records of the human subject, and updating the database to further associate the medical records with the human subject.

16. The method according to claim 1, wherein the method further comprises receiving conduct records of the human subject, and updating the database to further associate the conduct records with the human subject.

17. A computer server for generating a personnel records database comprising data entries associated with a plurality of human subjects, the computer server comprising a server processor, a data storage device storing server processor program instructions, the server processor program instructions being operative to cause the server processor:
for each of a plurality of human subjects,
(a) to receive information characterizing an educational qualification held by the human subject, wherein said information is indicative of an identity of an educational institution associated with the education qualification and an identity of the human subject;
(b) to transmit an electronic request for verification of the educational qualification to a verification server;
(c) to receive an outcome of the verification from the verification server; and
if the verification is successful,
(di) to generate a data entry associating the educational qualification with the identity of the associated human subject; and
(dii) to store the data entry in a database in communication with the server processor.

18. The computer server of claim 17, wherein the data storage device stores further server processor program instructions, the server processor program instructions being operative to cause the server processor to perform the method according to claim 2.

19. A computerized network comprising:
a computer server;
a verification server in communication with the computer server, said verification server being configured to obtain verification of an educational qualification associated with an educational institution; and
a database in communication with the computer server;
said computer server comprising a server processor, a data storage device storing server processor program instructions, the server processor program instructions being operative to cause the server processor, for each of a plurality of human subjects:
(a) to receive information characterizing an educational qualification held by the human subject, wherein said information is indicative of an identity of an educational institution associated with the education qualification and an identity of the human subject;
(b) to transmit an electronic request for verification of the educational qualification to a verification server;
(c) to receive an outcome of the verification from the verification server; and
if the verification is successful,
(di) to generate a data entry associating the educational qualification with the identity of the associated human subject; and
(dii) to store the data entry in the database in communication with the server processor;
wherein the computerized network further comprises servers of a plurality of employing organizations in communication with the server processor, the server processor program instructions being operative to cause the server processor:
for the human subject having an employment relationship with one or more said employing organizations,
(e) to receive, from the server of the employing organization, employment information characterizing the human subject's employment with the employing organization, and
(f) to update the database to further associate the employment information with the human subject.
